(19) United States
(12) Patent Application Publication
(10) Pub. No.: US 2026/0159248 A1
(43) Pub. Date: Jun. 11, 2026

(54) METHOD AND SYSTEM FOR AUTOMATIC DETERMINATION OF THE MECHANICAL PLAY OF CONTROL SURFACES OF AN AIRCRAFT

(71) Applicant: Airbus Operations (S.A.S.), Toulouse (FR)

(72) Inventor: Frédéric Hollande, Toulouse (FR)

(21) Appl. No.: 19/408,716

(22) Filed: Dec. 4, 2025

(30) Foreign Application Priority Data
Dec. 9, 2024 (FR) FR2413634

(51) Int. Cl. B64D 45/00; B64F 5/40; G06Q 10/20; G08B 21/18

(52) U.S. Cl. CPC B64D 45/0005; B64F 5/40; G06Q 10/20; G08B 21/182; B64D 2045/0085

(57) ABSTRACT

A method and system for automatic determination of a real relative mechanical play between at least two actuators of a control surface of an aircraft includes executing a position control loop to control position of the at least two actuators, during at least one predetermined measurement period collecting first data and second data, determining from the first data a theoretical relative movement with no mechanical play between the at least two actuators, and determining from the second data and the theoretical relative movement a real relative mechanical play between the at least two actuators, and if the real relative mechanical play is above or equal to a predetermined threshold, sending an alert message. The disclosure enables a considerable reduction in the time taken to diagnose real mechanical play in control surfaces of the aircraft.

### TECHNICAL FIELD

The present disclosure concerns the determination of the real mechanical play existing in actuators of control surfaces of an aircraft.

### BACKGROUND

The flight controls of an aircraft are sensitive to the mechanical play existing in different mechanical parts constituting a flight control system of the aircraft such as actuators rotating control surfaces (e.g. ailerons, elevators) of the aircraft. In an aircraft a control surface is more particularly held in position by articulations (e.g. universal joints) at the level of actuators and at the level of the structure of the aircraft. These articulations introduce mechanical play, thereby creating a so-called “dead” zone where movement of the control surface is absent despite a movement of the actuators. Thus, hereinafter a “mechanical play” can be defined as the maximal distance of movement of the actuator or actuators that generates no perceptible movement of the control surface (and reciprocally movement of the control surface without movement of the actuators).

In some flight situations vibrations linked to this mechanical play are felt by the pilots at the level of the flight controls. If the vibrations are too severe the pilots may interrupt the flight to reroute the aircraft to a nearby airport. The aircraft is therefore immobilized on the ground, in particular to identify the mechanical play that might be the source of the vibrations felt.

At present mechanical play is identified manually, which leads to long times of immobilization of the aircraft, liable rapidly to reach half-days of interruption of operation. This therefore has a severe impact on the airline, air traffic, local management of the aircraft and its hardware and human maintenance resources.

It is therefore desirable to alleviate this drawback of the prior art. In particular it is desirable to provide a solution that makes it possible to reduce the time to identify and to characterize the mechanical play of the flight control surfaces of an aircraft.

### SUMMARY

There is proposed here a method for automatic determination of a real relative mechanical play between at least two actuators of a control surface of an aircraft. This method is implemented in a system implemented in the form of electronic circuitry and includes:
executing a position control loop to command a neutral position at least one of the at least two actuators and to slave the position of the other actuator of the at least two actuators to a set point signal of triangular or sinusoidal shape,
during execution of the position control loop collecting during at least one predetermined measurement period k where k is an integer such that 1≤k≤n, n being an even integer greater than equal to 2: first data representing measurements of the forces exerted by each of the at least two actuators for loading the control surface and second data representing measurements of movements of each of the at least two actuators,
determining from the collected first data a theoretical relative movement with no mechanical play between the at least two actuators,
determining from the collected second data and the theoretical relative movement determined a real relative mechanical play between the at least two actuators and, if the real relative mechanical play determined is above or equal to a predetermined threshold, sending an alert message.

The present disclosure therefore enables considerable reduction of the time to diagnose, that is to say to identify and characterize, the real mechanical play at the level of the articulations of the actuators and of the attachments to the structure of the control surfaces of the aircraft replacing the current manual method by an automatic method initiated from the cockpit. It is therefore possible for airlines wishing it to optimise their scheduled maintenance strategy. In particular an airline can prioritize shorter scheduled maintenance intervals in order to reduce the risk of operational interruptions for vibrational problems linked to the real mechanical play of the control surfaces.

In one embodiment the real relative mechanical play is determined from the following equation:

$${J}_{i , j} = \frac{2}{n} {\sum }_{k}^{1 \leq k \leq n} ( \vert ( {Xm}_{i , k} - X {m}_{j , k} ) \vert - \frac{\vert {Fm}_{i , k} - F {m}_{j , k} \vert}{2 * {K}_{i , j}} )$$

where:
n is an even integer greater than or equal to 2, Xm_{i,k} and Xm_{j,k} corresponding for each of the at least two actuators (i, j) to a mean value of the second data, K_{i,j} corresponding to an inter-actuator stiffness between the at least two actuators (i, j), Fm_{i, k} and Fm_{j, k} corresponding for each of the at least two actuators to a mean value of the first data.

In one embodiment the method further includes correcting an adjustment error between the at least two actuators.

In one embodiment the control loop comprises a first direct gain control loop combined with a second control loop including an integrator.

There is also proposed here a method of maintaining at least one actuator of a control surface of an aircraft, including:
determining automatically a real relative mechanical play between at least two actuators of the control surface using an automatic determination method as described above,
   effecting and/or scheduling maintenance of at least one of the at least two actuators when an alert message is sent following execution of an automatic determination method as described above.

There is also proposed here a system for automatic determination of a real relative mechanical play between at least two actuators of a control surface of an aircraft. The system includes electronic circuitry configured:
to execute a position control loop to command a neutral position of at least one of the at least two actuators and to slave the position of the other actuator of the at least two actuators to a set point signal of triangular or sinusoidal shape,
during execution of the position control loop to collect during at least one predetermined measurement period k where k is an integer such that 1≤k≤n, n being an even integer above or equal to 2: first data representing measurements of the forces exerted by each of the at least two actuators for loading the control surface and second data representing measurements of the movements of each of the at least two actuators,
to determine from the collected first data a theoretical relative movement without mechanical play between the at least two actuators,
to determine from the collected second data and the theoretical relative movement determined a real relative mechanical play between the at least two actuators and, if the real relative mechanical play determined is above or equal to a predetermined threshold, sending an alert message.

There is also proposed here an aircraft including the system as described above.

There is also proposed a computer program product including instructions leading to execution by a processor of any embodiment of the method referred to above when the instructions are executed by the processor. There is also proposed a storage medium storing such instructions.

### BRIEF DESCRIPTION OF THE DRAWINGS

The features of the disclosure mentioned hereinabove and others will become more clearly apparent on reading the following description of at least one embodiment, the description being given with reference to the appended drawings, in which:

FIG. 1 depicts schematically in side view an aircraft equipped with one embodiment of a system for automatic determination of a real relative mechanical play between at least two actuators of a control surface of an aircraft;

FIG. 2 depicts schematically an example of a hardware architecture of one embodiment of a system for automatic determination of a real relative mechanical play between at least two actuators of a control surface of an aircraft;

FIG. 3 depicts in the form of a block diagram the steps of one embodiment of a method for determination of a real relative mechanical play between at least two actuators of a control surface of an aircraft;

FIG. 4 depicts in the form of a graphic an example of movement of two actuators of the same control surface of an aircraft in one embodiment of the method for determination of a real relative mechanical play between the two actuators of a control surface of an aircraft;

FIG. 5 depicts diagrammatically one embodiment of a position servocontrol loop controlling the position of the actuators of a control surface of an aircraft.

### DETAILED DESCRIPTION

The general principle of the present disclosure concerns automatic determination of the real mechanical play in actuators of a control surface of an aircraft. This determination is referred to as “automatic” because it is effected without human intervention, as opposed to the manual method known in the prior art. The present disclosure applies to aircraft that have control surfaces that can be rotated by two or more actuators. Each actuator is already equipped with at least one pressure or force sensor adapted to measure an extension and a retraction force of the actuator and at least one position sensor adapted to measure a movement of the actuator. The term “force” is defined here as being all of the forces that the actuator exerts to move the control surface, either during movement in a so-called “extension” direction or during movement in a so-called “retraction” direction. The term “extension” corresponds to a movement of the actuator by which the actuator is deployed or lengthened relative to a starting position (e.g. a neutral position). The term “retraction” corresponds to a movement of the actuator by which the actuator is folded or shortened relative to a starting position.

It is considered hereinafter by way of illustration that a control surface has two actuators. Note that the method described hereinafter can equally well apply to control surfaces with more than two actuators.

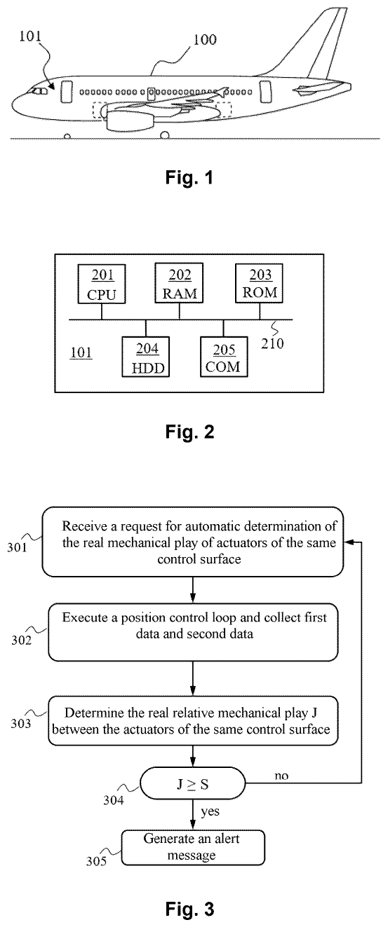

FIG. 1 thus depicts schematically in side view an aircraft 100 equipped with one embodiment of a system 101 for automatic determination of the real relative mechanical play between at least two actuators of a control surface of the aircraft 100 (also referred to hereinafter as the system 101).

The system 101 comprises electronic equipment onboard the aircraft 100. For example, the system 101 forms part of the electronic circuitry of the avionics of the aircraft 100. For example, the system 101 is integrated into the flight control computers of the aircraft 100. The flight control computers are configured to transmit a control surface order (e.g. in the form of a rotation angle of the control surface) to the actuators which then rotate the control surfaces of the aircraft 100. The flight control computers are moreover configured to receive measurements from the pressure sensors and the sensors of the positions of the actuators of the control surfaces of the aircraft 100.

The system 101 is therefore configured to exploit the capabilities of the flight control computers of the aircraft 100 and in particular to use data and measurements already made available to the flight control computers of the aircraft 100. The present disclosure therefore does not necessitate the use of new hardware (e.g. sensor, gauge or new processor).

The system 101 is furthermore configured to receive via a human-machine interface in the cockpit of the aircraft 100 a request for automatic determination of the mechanical play of the actuators of control surfaces of the aircraft 100.

FIG. 2 depicts schematically an example of a hardware platform enabling implementation in the form of electronic circuitry of one embodiment of the system 101.

The hardware platform includes, connected by a communication bus 210, a processor or CPU (Central Processing Unit) 201; a random access memory (RAM) 202; a read only memory (ROM) 203 or an electrically-erasable programmable memory (EEPROM) such as a flash memory; a storage unit 204 such as a hard disc drive (HDD) or a storage medium reader such as an SD (secure digital) card reader; and an interface manager (COM) 205.

The interface manager COM 205 enables the system 101 to interact with the avionic systems of the aircraft 100 such as: the flight control computers and the human-machine interface in the cockpit of the aircraft 100 via which a user (e.g. a technician, a pilot, etc.) requests an automatic diagnosis of the real mechanical play existing in the actuators of control surfaces of the aircraft 100.

The processor 201 is capable of executing instructions loaded into the random access memory 202 from the read-only memory 203, from an external memory, from a storage medium (such as an SD card), or from a communication network. When the hardware platform is powered up the processor 201 is capable of reading instructions from the random access memory 202 and executing them. These instructions form a computer program causing implementation by the processor 201 of some or all of the steps or processes or more broadly operating sequences of the aircraft described in the present description.

Some or all of the steps, processes and operations described here can therefore be implemented in the form of software by execution of a set of instructions by a programmable machine, for example a digital signal processor (DSP) or a microcontroller, or implemented in the form of hardware by a dedicated electronic machine or component (chip) or a set of dedicated electronic components (chipset), for example a field programmable gate array (FPGA) or an application specific integrated circuit (ASIC). Generally speaking, the system 101 includes electronic circuitry adapted and configured to implement some or all of the operations, processes and steps described here.

FIG. 3 depicts in the form of a diagram steps of a method according to one embodiment for automatic determination of the real relative mechanical play between at least two actuators of the same control surface of the aircraft 100. Some or all of this method is implemented by the system 101 described hereinabove.

In effect, in order to be able to diagnose mechanical play in actuators of control surfaces of the aircraft 100 the system 101 determines a real relative mechanical play between the various actuators of the same control surface.

First of all, during a step 301 a user (e.g. a technician, a pilot, etc.) requests an automatic diagnosis of the real mechanical play existing in the actuators of one or more control surfaces of the aircraft 100. To this end the user interacts with a human-machine interface in the cockpit of the aircraft 100. This human-machine interface then transmits to the system 101 a request for automatic determination of the real mechanical play of the actuators of one or more control surfaces of the aircraft 100. On receiving this automatic determination request the system 101 performs the automatic diagnosis of the real mechanical play in the actuators of one or more control surfaces of the aircraft 100. This automatic diagnosis includes the steps 302 to 304 described hereinafter.

During step 302 a first actuator, denoted i, is commanded to produce a neutral position (i.e. a zero position) and the second actuator, denoted j, is slaved to a signal of triangular or sinusoidal shape by a position control loop. This induces an antagonistic force between the two actuators i and j, respectively in traction and then in compression, for each of the actuators i and j.

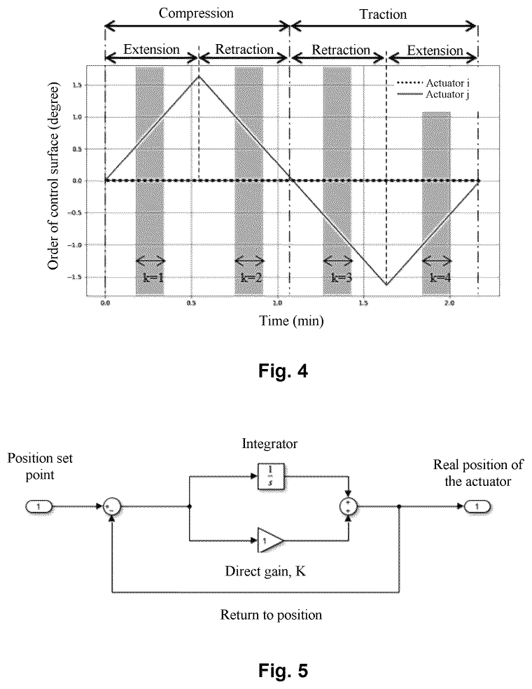

This position control loop of the system 101 sends a position set point for the actuators i and j. This set point is then transmitted to the flight control computer which determines, in particular on the basis of this set point, a command for movement of the actuators to rotate the control surface concerned. The position sensors integrated in and/or associated with the actuators i and j measure the movement of the actuators i and j and transmit the movement measurements (or positions) to the flight control computer. If necessary the flight control computer corrects the position of the actuators i and j in order to reduce the difference between the position set point and the real position of the actuators i and j. FIG. 4 depicts in the form of a graphic an example of the movement according to this position control loop of two actuators i and j of the same control surface of the aircraft 100 during this step 302.

Slaving the second actuator j to the signal of triangular or sinusoidal shape leads to it moving in a so-called extension direction and then in a so-called retraction direction relative to a starting position.

In one embodiment the maximal amplitude of the signal of triangular or sinusoidal shape is less than the load limit of the actuators, for example 80% of the load limit of the actuators.

The flight control computer 100 of the aircraft then receives from the pressure and position sensors integrated in and/or associated with the actuators i and j respectively measurements of forces and measurements of movements (or positions) of the actuators i and j. These measurements of forces and movements are effected at a predetermined frequency and over one or more predetermined periods known as measurement periods, denoted k, with k an integer such that 1≤k≤n, n being an even integer greater than or equal to 2, during a measurement cycle. In an example linked to FIG. 4 the measurement cycle comprises four measurement periods such that k=1, k=2, k=3 and k=4. In one embodiment these measurement periods are sized (in terms of time) so that they enable the acquisition of a large number of measurements of forces and movements, for example of the order of 300 measurements per period.

The flight control computer then stores the following data in a memory for each measurement period k=1, k=2, k=3, k=4 and for each actuator i and j:
first data corresponding to measurements of forces denoted F_{i,k} and F_{j,k} exerted by each of the actuators i and j, and second data corresponding to measurements of movements (or positions) denoted X_{i, k} and X_{j, k} of each of the actuators i and j.

The system 101 then collects this first and second data via the flight control computer. The system 101 then aggregates this data for each measurement period k, for example by determining from this data:
first information corresponding to the mean value of the measurements of forces exerted by the actuator i, denoted Fm_{i, k}, respectively by the actuator j, denoted Fm_{j, k},
second information corresponding to the mean value of the measurements of movements (or positions) of the actuator i, denoted Xm_{i, k}, respectively of the actuator j, denoted Xm_{j, k}.

In an embodiment described with reference to FIG. 5 the position control loop enabling the system 101 and the flight control computer to control the position of each of the two actuators i and j comprises a first control loop with direct gain K combined with a second control loop comprising an integrator (also referred to as an integrating servocontrol loop). The use of this complementary integrating servocontrol loop enables the accuracy of the measurements of the forces and the positions of the two actuators i and j to be increased by reducing the difference between the position set point and the positions of the actuators i and j measured by position sensors integrated in and/or associated with the actuators i and j. It makes it possible in particular to limit the range of movement of the actuator slaved to zero movement, which movement is induced by the movement of the actuator slaved to a signal of triangular or sinusoidal shape. The reduced range of movement enables the precision of the measurements of movements of the “static” actuator (i.e, the actuator slaved to a zero value) to be increased.

During a step 303 the system 101 determines the real relative mechanical play between the two actuators i and j of the control surface concerned on the basis of the aforementioned first and second information. The system 101 more particularly determines firstly, for each measurement period k, the difference, denoted X_{i, j, k}, between the mean value of the measurements of movements of the actuator i Xm_{i, k} and of the actuator j Xm_{j, k} and the theoretical relative movement with no mechanical play, denoted Y_{i, j}, k, between the actuators i and j that are calculated from the mean value of the measurements of forces exerted by the actuator i Fm_{i, k} and by the actuator j Fm_{j, k} using the following equation EQ1:

$${Y}_{i , j , k} = \frac{\vert ( {Fm}_{i , k} - F {m}_{j , k} ) \vert}{2 * {K}_{i , j}}$$

K_{i,j} corresponds to the inter-actuator stiffness which is known from the design of the aircraft 100 and is also systematically measured during the development of each aircraft. The various inter-actuator stiffnesses are stored for example in a table or in a database accessible to the system 101.

Thus, for each measurement period k the difference X_{i, j, k} is obtained from the following equation EQ2:

$${X}_{i , j , k} = \vert ( {Xm}_{i , k} - X {m}_{j , k} ) \vert - \frac{\vert ( {Fm}_{i , k} - F {m}_{j , k} ) \vert}{2 * {K}_{i , j}}$$

The real relative mechanical play, denoted J_{i,j}, between the actuators i and j is equal to the sum of the differences X_{i, j, k} in compression and in traction. In the example linked to FIG. 4 the measurement cycle includes two compression measurement periods: k=1 and k=2, and two traction measurement periods: k=3 and k=4. The real relative mechanical play J_{i,j} is therefore measured twice: a first time in the periods: k=1 (compression/extension) and k=3 (traction/retraction) and a second time in the periods: k=2 (compression/retraction) and k=4 (traction/extension). The real relative mechanical play J_{i,j} is equal to the mean value of these two measurements. The real relative mechanical play J_{i,j} between these two actuators i and j where i=1 and j=2 and k∈{1, 2, 3, 4} is therefore determined from the following equation EQ3:

$${J}_{12} = \frac{2}{n} {\sum }_{k}^{1 \leq k \leq n} ( \vert ( {Xm}_{1 , k} - X {m}_{, 2 k} ) \vert - \frac{\vert ( {Fm}_{1 , k} - F {m}_{2 , k} ) \vert}{2 \cdot {K}_{12}} )$$

Note that when the control surface is moved by two actuators the real relative mechanical play J_{i,j} between the two actuators corresponds to the sum of the mechanical play of each of the two actuators.

In one particular embodiment when the control surface is actuated by three actuators the automatic diagnosis is similar to what has been described above with reference to steps 302 and 303 but is executed in three different actuator configurations whereas a single actuator configuration is sufficient in the case of a control surface actuated by two actuators. More particularly in the case of three actuators first, second and third actuators are in turn either slaved to a zero value or to the signal of triangular or sinusoidal shape or commanded to a passive mode (or damped). The passive mode is the mode in which the actuator is not controlled in position and merely tracks the position of the active actuators (i.e. is slaved to a zero value or to a signal of sinusoidal or triangular shape). The actuator commanding the passive mode is therefore not involved in the determination of the real relative mechanical play between the other two active actuators concerned for the automatic diagnosis.

For a first actuator 1, a second actuator 2 and a third actuator 3 the three actuator configurations are as follows:
first configuration: the first actuator 1 is slaved to a zero value, the second actuator 2 is slaved to the signal of triangular or sinusoidal shape, the third actuator 3 is commanded to the passive mode or damped; the system 101 determines the real relative mechanical play between the first actuator and the second actuator, denoted J₁₂, in this first configuration using the above equation EQ3;
second configuration: the first actuator 1 is commanded to the passive mode, the second actuator 2 is slaved to a zero value, the third actuator 3 is slaved to the signal of triangular or sinusoidal shape; the system 101 determines the real relative mechanical play between the second actuator and the third actuator, denoted J₂₃, in the second configuration using the above equation EQ3;
third configuration: the first actuator 1 is slaved to a zero value, the second actuator 2 is commanded to the passive mode, the third actuator 3 is slaved to the signal of triangular or sinusoidal shape; the system 101 determines the real relative mechanical play between the first actuator and the third actuator, denoted J₁₃, in this third configuration using the above equation EQ3.

Thus, in the case of a control surface moved by three actuators the total real relative mechanical play of each actuator is determined. The total real relative mechanical play corresponds to the real individual mechanical play for each actuator (1, 2, 3), that is to say:

$${J}_{1} = \frac{1}{2} \cdot {J}_{12} - \frac{1}{2} \cdot {J}_{23} + \frac{1}{2} \cdot {J}_{13}$$

$${J}_{2} = \frac{1}{2} \cdot {J}_{12} + \frac{1}{2} \cdot {J}_{23} - \frac{1}{2} \cdot {J}_{13}$$

$${J}_{3} = - \frac{1}{2} \cdot {J}_{12} + \frac{1}{2} \cdot {J}_{23} + \frac{1}{2} \cdot {J}_{13}$$

J₁ is the real individual mechanical play of the first actuator 1, J₂ is the real individual mechanical play of the second actuator 2, and J₃ is the real individual mechanical play of the third actuator 3.

As described above there is an antagonistic force between the two actuators i and j. The two actuators i and j being in opposition their pressure sensors therefore measure the same force except for the sign. Furthermore in some aircraft architectures the actuators comprise two independent pressure sensors: a first pressure sensor for monitoring the force of the actuator and a second pressure sensor for validation of the signals and the system. Thus, in one embodiment in order for the measurement of the forces to be even more precise the average value of the forces measured by the two sensors of the two actuators during movement in extension and retraction is determined. The mean value of the measurements of forces exerted on the actuator i over the period k, denoted Fmᵢ, k, therefore corresponds to the mean value of the measurements of forces effected by the first sensor 1 (Fm1_{i, k}) and by the second sensor 2 (Fm2_{i, k}), that is to say:

$${Fm}_{i , k} = ( Fm {1}_{i , k} + Fm {2}_{i , k} ) / 2.$$

During a step 304 the real relative mechanical play J_{i,j} between the two actuators i and j is compared to a predetermined threshold S. If the real relative mechanical play J_{i,j} is equal to or above this predetermined threshold S an alert message is generated by the system 101 in a step 305 in order to notify the crew (for example via the human-machine interface) and/or personnel on the ground by way of air-ground communication of a requirement for maintenance to be verified and/or effected on the actuators. Note that if a control surface is moved by more than two actuators it is the individual mechanical play at the level of each of the actuators that is compared to the predetermined threshold S.

In one embodiment this alert message includes a request for maintenance of the equipment to be effected and/or scheduled. In one example, in the case of a control surface actuated by two actuators the alert message enables identification of the control surface that has too high a play. In another example, in the case of a control surface actuated by more than two actuators the message includes supplementary information that specifies the equipment in which there is excessive play.

The automatic determination method the various embodiments of which have been described hereinabove therefore enables an automatic diagnosis to be obtained of the real mechanical play of the control surface actuators in a few minutes instead of several half-days using the existing manual method. In other words, the determination method as described hereinabove enables a method of maintaining the actuators of the control surfaces of the aircraft 100 to be carried out. In particular, thanks to the generation of an alert message including in particular a request for maintenance to be effected and/or scheduled, a technician/operator for example can effect and/or schedule maintenance of these actuators.

Prior to this automatic diagnosis the system 101 optionally corrects the adjustment error between the two actuators i and j. Here the term “adjustment error” designates the position difference between two actuators slaved by the same order. To this end the control loop further includes an integrator in parallel with the loop in order to limit any error between the position set point and the movement measurement. The first actuator i is first slaved to a zero value (i.e. a neutral position). The position sensors integrated in and/or associated with the second actuator j then measure its position denoted Xⱼ₀. The position Xⱼ₀ of the second actuator j is then sent to the flight control computer. During the automatic diagnosis (i.e. steps 302 to 304) the commanded position of the second actuator j is therefore offset by −Xⱼ₀ in order to compensate the adjustment error between the two actuators i and j. This preliminary step enables the precision of the position measurements to be increased.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for automatic determination of a real relative mechanical play between at least two actuators of a control surface of an aircraft, the method being implemented in a system comprising electronic circuitry, the method comprising:
executing a position control loop to command a neutral position of at least one of the at least two actuators and to slave a position of another actuator of the at least two actuators to a set point signal of triangular or sinusoidal shape;
during execution of the position control loop collecting during at least one predetermined measurement period k where k is an integer such that 1≤k≤n, n being an even integer greater than equal to 2: first data representing measurements of forces exerted by each of the at least two actuators for moving the control surface and second data representing measurements of movements of each of the at least two actuators;
determining from the collected first data a theoretical relative movement with no mechanical play between the at least two actuators; and
determining from the collected second data and the theoretical relative movement determined a real relative mechanical play between the at least two actuators (i, j) and, if the real relative mechanical play determined is above or equal to a predetermined threshold, sending an alert message.

2. The method of claim 1 wherein the real relative mechanical play is determined from an equation of:
$${J}_{i , j} = \frac{2}{n} {\sum }_{k}^{1 \leq k \leq n} ( \vert {Xm}_{i , k} - X {m}_{j , k} \vert - \frac{\vert {Fm}_{i , k} - F {m}_{j , k} \vert}{2 * {K}_{i , j}} )$$
where:
n is an even integer greater than or equal to 2,
Xm_{i,k} and Xm_{j,k} correspond for each of the at least two actuators to a mean value of the second data,
K_{i,j} corresponds to an inter-actuator stiffness between the at least two actuators,
Fm_{i, k} and Fm_{j, k} correspond for each of the at least two actuators to a mean value of the first data.

3. The method of claim 1, further comprising correcting an adjustment error between the at least two actuators.

4. The method of claim 1, wherein the control loop comprises a first direct gain control loop combined with a second control loop including an integrator.

5. A method of maintaining at least one actuator of a control surface of an aircraft, comprising:
determining automatically a real relative mechanical play between at least two actuators of the control surface using the method of claim 1; and
effecting and/or scheduling maintenance of at least one of the at least two actuators when an alert message is sent.

6. A system for automatic determination of a real relative mechanical play between at least two actuators of a control surface of an aircraft, the system including electronic circuitry configured:
to execute a position control loop to command a neutral position of at least one of the at least two actuators and to slave a position of another actuator of the at least two actuators to a set point signal of triangular or sinusoidal shape;
during execution of the position control loop to collect during at least one predetermined measurement period k where k is an integer such that 1≤k≤n, n being an even integer above or equal to 2: first data representing measurements of the forces exerted by each of the at least two actuators for loading the control surface and second data representing measurements of the movements of each of the at least two actuators;
to determine from the collected first data a theoretical relative movement without mechanical play between the at least two actuators; and
to determine from the collected second data and the theoretical relative movement determined a real relative mechanical play between the at least two actuators, and, if the real relative mechanical play determined is above or equal to a predetermined threshold, send an alert message.

7. An aircraft including the system of claim 6.

8. A computer program product including instructions leading to execution by a processor of the method of claim 1 when the instructions are executed by the processor.

9. A storage medium storing a computer program including instructions leading to execution by a processor of the method of claim 1 when the instructions are read and executed by the processor.
